(19) United States
(12) Patent Application Publication
(10) Pub. No.: US 2017/0285924 A1
(43) Pub. Date: Oct. 5, 2017

(54) METHOD FOR ADJUSTING PLAY PROGRESS AND ELECTRONIC DEVICE

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Ruotao WANG, Beijing (CN)

(21) Appl. No.: 15/246,758

(22) Filed: Aug. 25, 2016

Related U.S. Application Data
(63) Continuation of application No. PCT/CN2016/088771, filed on Jul. 6, 2016.

(30) Foreign Application Priority Data
Mar. 31, 2016 (CN) 201610202015.5

(51) Int. Cl. G06F 3/0484; G11B 27/031; G11B 27/34

(52) U.S. Cl. CPC G06F 3/04847; G11B 27/34; G11B 27/031

(57) ABSTRACT

A method for adjusting play progress is disclosed. The method includes: receiving a first drag instruction of a user acted on a progress bar of a player, and adjusting the play progress to a first time point corresponding to an end position of the first drag instruction according to the first drag instruction; when the first drag instruction is ended, generating a sub-progress bar at the end position of the first drag instruction, the sub-progress bar corresponding to a multimedia segment within a preset duration before and after the first time point; and receiving a first drag instruction of the user acted on the sub-progress bar, and adjusting the play progress to a second time point corresponding to an end position of the second drag instruction according to the second drag instruction.

### CROSS REFERENCE TO RELATED APPLICATIONS

The present disclosure is a continuation application of PCT International patent application No. PCT/CN2016/088771, filed on Jul. 6, 2016, which claims priority to Chinese Patent Application No. 201610202015.5, filed with the Chinese Patent Office on Mar. 31, 2016, both of which are herein incorporated by reference in their entireties.

### TECHNICAL FIELD

The present disclosure relates to the field of multimedia playing technologies, and more particularly, to a method for adjusting play progress and electronic device.

### BACKGROUND

In the process of playing a video through a terminal device at present, if a user wants to adjust a play progress, the user will drag a progress bar to a certain position by fingers to adjust the play progress generally. The user may adjust the play progress more exactly only in a manner of slowly dragging the progress bar. In general, dragging the progress bar for every 1 mm means that the video will have a spanning more than 3 s, such that the user cannot find the frame expected thereof usually. The user needs to drag the progress bar by fingers in a touch terminal device particularly.

### SUMMARY

An embodiment of the present disclosure provides a method for adjusting play progress, including:

receiving a first drag instruction of a user acted on a progress bar of a player, and adjusting the play progress to a first time point corresponding to an end position of the first drag instruction according to the first drag instruction;
when the first drag instruction is ended, generating a sub-progress bar at the end position of the first drag instruction, the sub-progress bar corresponding to a multimedia segment within a preset duration before and after the first time point; and
receiving a second drag instruction of the user acted on the sub-progress bar, and adjusting the play progress to a second time point corresponding to an end position of the second drag instruction according to the second drag instruction.

Another embodiment of the present disclosure provides an electronic device, the electronic device includes: at least one processor ,and a memory. The memory is communicably connected with the at least one processor and for storing instructions executable by the at least one processor. Wherein execution of the instructions by the at least one processor causes the at least one processor to:

receive a first drag instruction of a user acted on a progress bar of a player, and adjust the play progress to a first time point corresponding to an end position of the first drag instruction according to the first drag instruction;
when the first drag instruction is ended, generate a sub-progress bar at the end position of the first drag instruction, the sub-progress bar corresponding to a multimedia segment within a preset duration before and after the first time point; and
receive a second drag instruction of the user acted on the sub-progress bar, and adjust the play progress to a second time point corresponding to an end position of the second drag instruction according to the second drag instruction.

Still another embodiment of the present disclosure provides a non-transitory computer-readable storage medium. The non-transitory computer-readable storage medium stores executable instructions, wherein when the executable instructions are executed by an electronic device, causes the electronic device to:

receive a first drag instruction of a user acted on a progress bar of a player, and adjust the play progress to a first time point corresponding to an end position of the first drag instruction according to the first drag instruction;
when the first drag instruction is ended, generate a sub-progress bar at the end position of the first drag instruction, the sub-progress bar corresponding to a multimedia segment within a preset duration before and after the first time point; and
receive a second drag instruction of the user acted on the sub-progress bar, and adjust the play progress to a second time point corresponding to an end position of the second drag instruction according to the second drag instruction.

### BRIEF DESCRIPTION OF THE DRAWINGS

To describe embodiments of the present disclosure or the technical solution in the related art, hereinafter, drawings that are to be referred for description of the embodiments or the related art are briefly described. Apparently, the drawings described hereinafter merely illustrate some embodiments of the present disclosure. Persons of ordinary skill in the art may also derive other drawings based on the drawings described herein without any creative effort.

FIG. 1 is a flow chart illustrating a method for adjusting play progress according to one embodiment of the present disclosure;

FIG. 2 is a flow chart illustrating a method for adjusting play progress according to another embodiment of the present disclosure;

FIG. 3 is a structural schematic diagram illustrating an apparatus for adjusting play progress according to one embodiment of the present disclosure; and

FIG. 4 is a schematic structural diagram illustrating a playing terminal according to one embodiment of the present disclosure.

### DETAILED DESCRIPTION

To make the objectives, technical solutions, and advantages of the present disclosure clearer, the present disclosure is described in detail with reference to the accompanying drawings and specific embodiments.

It should be noted that, the terms “first” and “second” used in the embodiments of the present disclosure denote two non-identical entities or non-identical parameters having the identical name. It is apparent that the terms “first” and “second” are given herein for illustration convenience, and shall not be construed as limiting the embodiments of the present disclosure. Such terms are not described in the following embodiments any further.

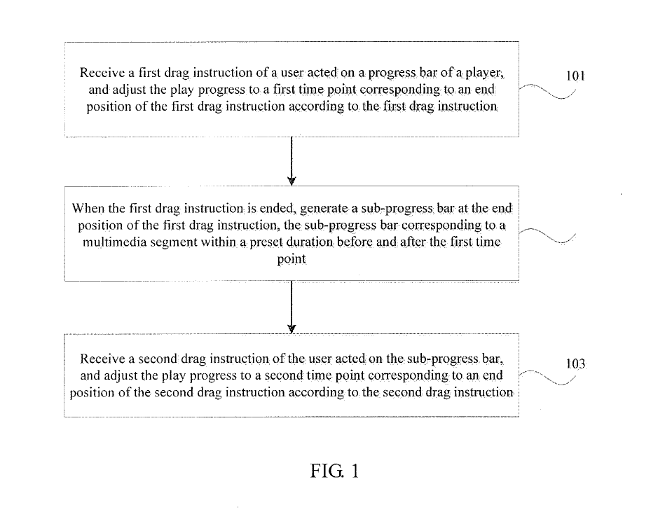

In one aspect, the embodiments of the present disclosure provide a method for adjusting play progress. FIG. 1 is a flow chart illustrating a method for adjusting play progress according to one embodiment of the present disclosure.

The method for adjusting play progress includes following steps.

In step 101, a first drag instruction of a user acted on a progress bar of a player is received, and the play progress is adjusted to a first time point corresponding to an end position of the first drag instruction according to the first drag instruction.

In the step, the first drag instruction is generally acted on the progress bar of the player and configured to represent an indicator of the current play progress. When the user selects the indicator to conduct a drag operation, the first drag instruction is then input. After the first drag instruction is received, a predetermined setting is invoked; in this way, the adjusting quantity of a corresponding play progress may be determined according to a drag length of the first drag instruction, and then the play progress is finally adjusted to the first time point corresponding to the end position of the first drag instruction. The predetermined setting above is namely a corresponding relationship between the drag length of the drag operation and the adjusting quantity of the play progress determined according to the total duration of the video played. The contents belong to the prior art, and will not be elaborated in the embodiment of the present disclosure.

In step 102, when the first drag instruction is ended, a sub-progress bar is generated at the end position of the first drag instruction, the sub-progress bar corresponding to a multimedia segment within a preset duration before and after the first time point.

In the step, a continuing process of the first drag instruction is monitored; when the first drag instruction is ended, the end position of the first drag instruction is determined, and one sub-progress bar is generated at the end position of the first drag instruction. Being different from the progress bar of the player, the sub-progress bar is not corresponding to the entire video, but is merely corresponding to the multimedia segment within the preset duration before and after the first time point, i.e., a small segment of video near the first time point. Wherein, the value of the preset duration ranges from 1 s to 3 s; taking the preset duration as 1 s for example, the sub-progress bar is namely corresponding to video segments having a length of 2 s before and after the first time point.

In a general case, the progress bar of the player is displayed in a transverse manner; in order to ensure the discriminative display effect of the sub-progress bar, the sub-progress bar is set to be displayed in a longitudinal manner, or displayed using a circular and elliptic frame shape.

In step 103, a second drag instruction of the user acted on the sub-progress bar is received, and the play progress is adjusted to a second time point corresponding to an end position of the second drag instruction according to the second drag instruction, a unitary drag step length of the second drag instruction corresponding to the duration of one frame.

In the step, being similar to the first drag instruction, the second drag instruction is acted on the sub-progress bar and configured to represent an indicator of the current play progress. When the user selects the indicator to conduct a drag operation, the second drag instruction is then input. The play progress is adjusted to the second time point corresponding to the end position of the second drag instruction according to the second drag instruction. In the step, the unitary drag step length of the second drag instruction corresponding to the duration of one frame. That is, a duration corresponding to a minimum drag length of the second drag instruction acted on the sub-progress bar is the duration of one frame, and the user may minimally adjust the play progress one frame by one frame; when the drag length of the second drag instruction is greater than the unitary step length, the duration corresponding to a plurality of frames may also be adjusted continuously in a unit of the duration corresponding to one frame. When the second drag instruction is ended, the play progress will be adjusted to the second time point, and the player image is that frame of image corresponding to the second time point.

As apparent from the above embodiment, the method for adjusting play progress according to the embodiments of the present disclosure generates one sub-progress bar on the basis of the first adjustment of a default progress bar of the player to further adjust the play progress precisely in a unit of frames, such that the user can adjust the play progress precisely through simple and quick operations, and the user can adjust the play progress of the video to a certain frame expected thereof according to preferences thereof.

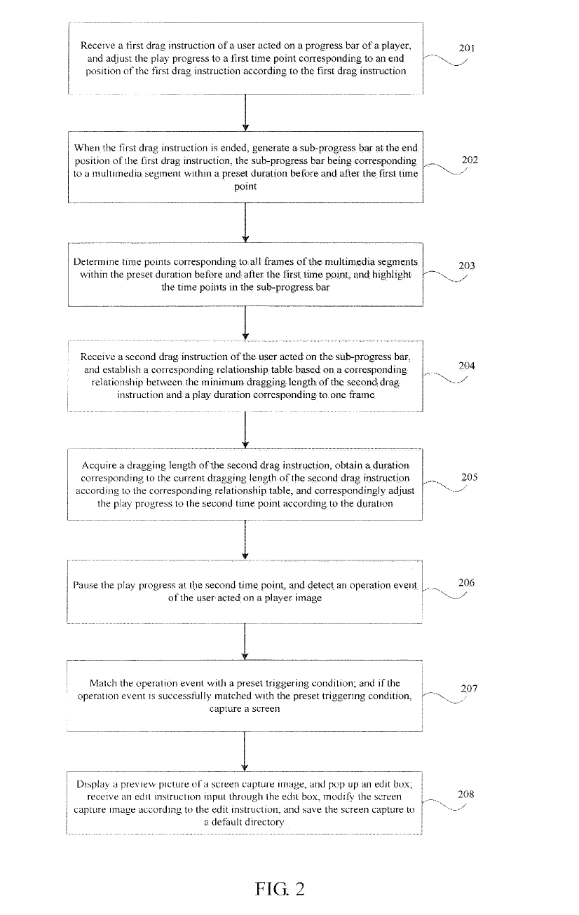

FIG. 2 is a flow chart illustrating a method for adjusting play progress according to another embodiment of the present disclosure.

As a more specific embodiment, the method for adjusting play progress includes the following steps.

In step 201, a first drag instruction of a user acted on a progress bar of a player is received, and the play progress is adjusted to a first time point corresponding to an end position of the first drag instruction according to the first drag instruction.

In step 202, when the first drag instruction is ended, a sub-progress bar is generated at the end position of the first drag instruction, the sub-progress bar corresponding to a multimedia segment within a preset duration before and after the first time point.

In step 203, time points corresponding to all frames of the multimedia segment within the preset duration before and after the first time point are determined, and the time points are highlighted in the sub-progress bar.

In the step, time points corresponding to all frames of a video segment corresponding to the sub-progress bar are determined firstly; taking the preset duration as 1 s and the video as a common film (1 s including 24 frames) for example, 48 time points corresponding to all the 48 frames will be determined firstly. then the 48 time points above are highlighted on the sub-progress bar; For example, the 48 time points above are displayed using marking lines vertical to the sub-progress bar, i.e., the display effect of the sub-progress bar similarly has “scale”, or the 48 time points are displayed through highlighted dots.

Through the method of highlighting the time points corresponding to all the frames in the video segment in this step, each frame may be effectively marked for the user, which helps the user adjust the play progress more precisely while dragging.

In step 204, a second drag instruction of the user acted on the sub-progress bar is received, and a corresponding relationship table based on a corresponding relationship between a minimum drag length of the second drag instruction and a play duration corresponding to one frame is established.

In step 205, a drag length of the second drag instruction is acquired, a duration corresponding to the current drag length of the second drag instruction is obtained according to the corresponding relationship table, and the play progress is correspondingly adjusted to the second time point according to the duration.

In steps 204 and 205, the corresponding relationship table includes the contents as follows: the corresponding relationship table includes a corresponding relationship between the drag length and a play duration corresponding to the drag length. For example, the minimum drag length of the second drag instruction is 1 mm, and the play duration corresponding to one frame is 0.04 s, then the corresponding relationship table is established based on a corresponding relationship between the minimum drag length of 1 mm and the corresponding play duration of 0.04. In the corresponding relationship table, the drag length is the integer multiple of the minimum drag length, while the play duration corresponding to the drag length is the integer multiple of the play duration corresponding to one frame accordingly. As the example above, if the drag length of the second drag instruction input by the user is 5 mm, then the corresponding adjusting quantity of the play progress is 0.2 s.

In step 206, the play progress is paused at the second time point, and an operation event of the user acted on a player image is detected.

After the play progress is adjusted to the second time point according to the second drag instruction, the play progress is paused at the second time point. Then the player image is detected continuously; when an input of the user on the player image is detected, the input is recorded as an operation event.

In the embodiment, the method is applied to a terminal having a touch input device. After the operation event is a slide touch event, when the slide touch event above is detected, a slide trace of the slide touch event is recorded.

In step 207, the operation event is matched with a preset triggering condition; and if the operation event is successfully matched with the preset triggering condition, a screen is captured.

Accordingly, a first triggering condition in the embodiment is a preset slide trace.

The slide trace of the operation event detected is matched with the preset slide trace. During matching, the slide trace of the operation event is judged whether to be the identical to the preset slide trace; if the slide traces are identical, then the matching is judged to be successful; if the slide traces are different, then the matching is judged to be failed. When the matching is successful, then a screen of the current player menu is further captured. When the matching is failed, no processing is performed.

During judgment, the expression “identical slide traces” does not imply that the slide traces are completely identical in an absolute sense, but refers to judging whether the two slide traces are similar enough, and one exemplary implementation manner for judging whether the slide traces are similar enough is: presetting a similarity threshold; comparatively analyzing the slide trace input by the user and the preset slide trace to calculate out a similarity; if the similarity calculated out reaches the similarity threshold, then the two slide traces are deemed as to be similar enough, and the matching is judged to be successful; otherwise, the matching is judged to be failed.

Through the step 206 and the step 207, the user is enabled to further capture the screen of the player image through a quick triggering operation on the basis of precisely adjusting the play progress to a certain frame. In the embodiment, the user triggers to capture the screen through a slide touch control, and the operation event for triggering to capture the screen, according to different application circumstances and use requirements, may also be: a double-click operation on the player image, or a heavy-press or light-press operation on the player image (while being applied to a terminal having a 3D Touch function), or the like.

In step 208, a preview picture of a screen capture image is displayed, and an edit box is popped up; and an edit instruction input through the edit box is received, the screen capture image is modified according to the edit instruction, and the screen capture image is saved to a default directory.

After the screen is completely captured, a window is newly established to display the preview picture of the screen capture image to the user and pop up the edit box for the user to input in the meanwhile. The user may input an edit instruction through the edit box to simply modify the screen capture image, for instance, adding a text including a personal comment of the user on the screen capture image, inserting other decorative pictures, or the like. The screen capture image is modified according to the edit instruction input by the user, and then the modified screen capture image is saved to the default directory. Further, a prompt box may also be popped up after the edit instruction is completely processed, to ask the user whether to share the modified screen capture image to a friend immediately; when a confirmation instruction of the user is received, the modified screen capture image is pushed to a pre-bound friend.

As a more specific embodiment, the method for adjusting play progress according to the above embodiment further includes such functions as screen capturing, screen capture image modifying, or the like, provided to the user after adjusting the play progress, which further expands the application range of the method according to the present disclosure.

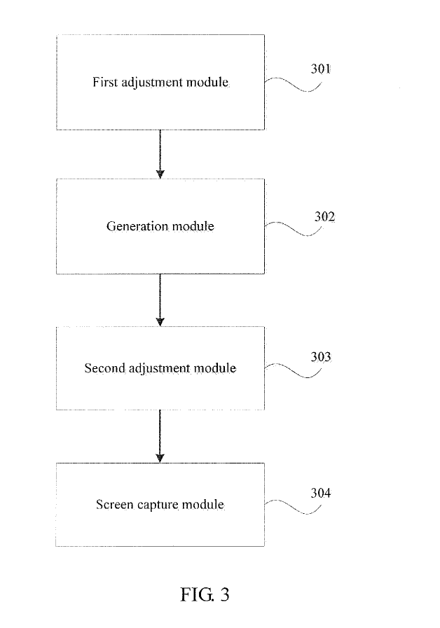

In another aspect, the embodiments of the present disclosure further provide an apparatus for adjusting play progress. FIG. 3 is a structural schematic diagram illustrating an apparatus 3 for adjusting play progress according to one embodiment of the present disclosure.

The apparatus 3 for adjusting play progress includes:

a first adjustment module 301, configured to receive a first drag instruction of a user acted on a progress bar of a player, and adjust the play progress to a first time point corresponding to an end position of the first drag instruction according to the first drag instruction;

a generation module 302, configured to, when the first drag instruction is ended, generate a sub-progress bar at the end position of the first drag instruction, the sub-progress bar corresponding to a multimedia segment within a preset duration before and after the first time point; and

a second adjustment module 303, configured to receive a second drag instruction of the user acted on the sub-progress bar, and adjust the play progress to a second time point corresponding to an end position of the second drag instruction according to the second drag instruction.

As apparent from the above embodiment, the apparatus for adjusting play progress according to the embodiments of the present disclosure generates one sub-progress bar on the basis of the first adjustment of a default progress bar of the player to further adjust the play progress precisely in a unit of frames, such that the user can adjust the play progress precisely through simple and quick operations, and the user can adjust the play progress of the video to a certain frame expected thereof according to preferences thereof.

In one exemplary embodiment, the second adjustment module 303 is further configured to: establish a corresponding relationship table based on a corresponding relationship between a minimum drag length of the second drag instruction and a play duration corresponding to one frame, the corresponding relationship table including a corresponding relationship between the drag length and a play duration corresponding to the drag length; and acquire a drag length of the second drag instruction, obtain a duration corresponding to the current drag length of the second drag adjust according to the corresponding relationship table, and correspondingly adjust the play progress to the second time point according to the duration. In one exemplary embodiment, the play duration corresponding to the drag length is an integral multiple of a play duration corresponding to one frame.

In one exemplary embodiment, the generation module 302 is further configured to: determine time points corresponding to all frames of the multimedia segment within the preset duration before and after the first time point, and highlight the time points in the sub-progress bar.

In one exemplary embodiment, the apparatus for adjusting play progress further includes: a screen capture module 304, configured to pause the play progress at the second time point; detect an operation event of the user acted on a player image; match the operation event with a preset triggering condition; and if the operation event is successfully matched with the preset triggering condition, capture a screen.

Further, the screen capture module 304 is further configured to: display a preview picture of a screen capture image, and pop up an edit box; and receive an edit instruction input through the edit box, modify the screen capture image according to the edit instruction, and save the screen capture image to a default directory.

The apparatus for adjusting play progress according to the above embodiment is configured to implement the corresponding method for adjusting play progress in the above embodiment, and has the advantageous effects of the corresponding method embodiments, which will not be elaborated herein.

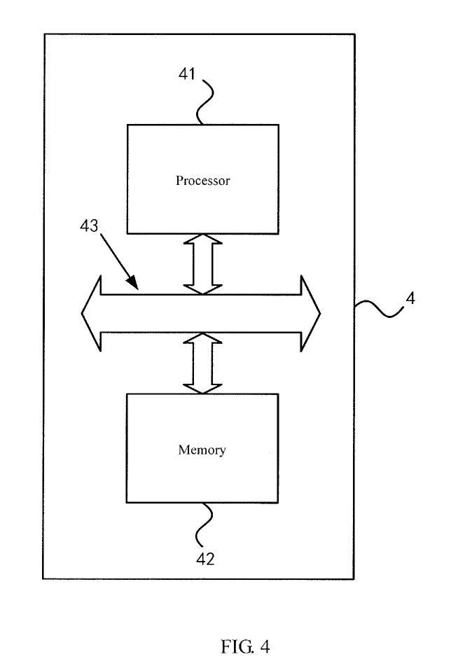

In still another aspect, the embodiments of the present disclosure further provide a playing terminal. FIG. 4 is a schematic structural diagram of a playing terminal according to one embodiment of the present disclosure. As illustrated in FIG. 4, the playing terminal 4 includes: a processor 41, a memory 42 and a bus system 43. The processor 41 and the memory 42 are connected to each other via the bus system 43, the memory 42 is configured to store instructions, and the processor 41 is configured to execute the instructions stored in the memory 42 to:

receive a first drag instruction of a user acted on a progress bar of a player, and adjust the play progress to a first time point corresponding to an end position of the first drag instruction according to the first drag instruction

when the first drag instruction is ended, generate a sub-progress bar at the end position of the first drag instruction, the sub-progress bar corresponding to a multimedia segment within a preset duration before and after the first time point; and

receive a second drag instruction of the user acted on the sub-progress bar, and adjust the play progress to a second time point corresponding to an end position of the second drag instruction according to the second drag instruction.

The memory 42 of the playing terminal 4 may be a non-volatile computer readable storage medium, which is configured to store computer executable instructions. When the instructions are executed by one or a plurality of central processors, for example, a processor may be caused to perform the steps in the above method embodiments, for example, steps 101 to 103 illustrated in FIG. 1, or steps 201 to 208 illustrated in FIG. 2, or the processor may be caused to implement the functions of the units in the above apparatus embodiments, for example, the functions of units 301 to 304 illustrated in FIG. 3. The computer executable instructions may also be stored and/or transmitted in any non-volatile computer readable storage medium, such that these instructions are used by an instruction executing system, apparatus or device, or used in combination with the instruction executing system, apparatus or device. The instruction executing system, apparatus or device may be, for example, a computer-based system, a system includes a processor or another system capable of acquiring instructions from the instruction executing system, apparatus or device and executing the instructions. For the purpose of this specification, the “non-volatile computer readable storage medium” may be any tangible medium including or storing computer executable instructions. The computer executable instructions may be used by the instruction executing system, apparatus or device, or used in combination with the executing system, apparatus or device. The non-volatile computer readable storage medium may include, but not limited to, a magnetic, optical and/or semiconductor storage device. Examples of these storage devices include a magnetic disk, an optical disc based on CD, DVD and Blu-ray technology, and permanent solid memory (for example, a flash memory, a solid driver and the like).

It should be understood that in the embodiments of the present application, the processor 41 may be a central processing unit (CPU). The processor 41 may be a general processor, a digital signal processor (DSP), an application specific integrated circuit (ASIC), a field programmable gate array (FPGA) or another programmable logic device, a discrete gate or transistor logic device, or a discrete hardware component. The general processor may be a microprocessor or any customary processor or the like.

In addition to a data bus, the bus system 43 may further include a power bus, a control bus, a state signal bus and the like. However, for clarity of description, various buses are all marked as the bus system 43.

In the embodiments of the present disclosure, the playing terminal is not limited to the components and configurations as illustrated in FIG. 4, but may further include other or additional components having a plurality of configurations.

During the implementation, various steps in the above method and various modules in the above apparatus may be implemented by means of an integrated logic circuit in the processor 41 or by means of software. The steps in the method and the units in the apparatus disclosed in the embodiments of the present disclosure may be directly embodied as being implemented by a hardware processor, or implemented by a combination of hardware in the processor and other software modules. The software module may be located in a random memory, a flash memory, a read-only memory, a programmable read-only memory, an electrically erasable programmable memory, a register or the like storage medium commonly known in the art. The storage medium is located in the memory 42. The processor 41 reads the information stored in the memory 42 and performs the steps of the above method in combination with the hardware thereof. For brevity of description, the details are not given herein any further.

Persons of ordinary skill in the art should understand that the discussion of any of the above embodiments is exemplary, and is not intended to imply that the scope of the present disclosure (including the claims) is limited to these exemplary embodiments. The above embodiments, or the technical features in different embodiments may be combined, the steps may be performed in any sequence, and various modifications may be made to different aspects of the present disclosure, which are not described in detail for brevity.

In addition, for simplicity of description and discussion and for ease of understanding of the present disclosure without obstacles, well known power/ground connections to integrated circuit (IC) chips and other components may or may not be shown in the drawings provided, for simplicity of illustration and discussion, and so as not to obscure the present disclosure. Further, the apparatus may be shown in a block diagram form in order to avoid obscuring the present disclosure, and also in view of the fact that details with respect to implementation of such block diagram apparatuses are highly dependent upon a platform within which the present disclosure is to be implemented (i.e., such details should be well within understanding of those skilled in the art). Where specific details (e.g., circuits) are set forth in order to describe the exemplary embodiments of the present disclosure, it should be apparent to those skilled in the art that the present disclosure may be practiced without, or with variation of, these specific details. The description is thus to be regarded as illustrative instead of limiting.

Although the present disclosure above has been described with reference to the specific embodiments of the present disclosure, various alternatives, modifications and variations to these embodiments are apparent to those skilled in the art in light of the above description. For example, the discussed embodiments may be used in other memory architectures (for example, a dynamic RAM (DRAM)).

The embodiments of the present disclosure are intended to embrace all such alternatives, modifications, and variations that fall within the spirit and broad scope of the appended claims. Therefore, any omission, modification, equivalent alternative, improvement and the like, made within the spirit and principle of the present disclosure, shall all fall within the protection scope of the present disclosure.

What is claimed is:

1. A method for adjusting play progress, comprising:
at a player,
receiving a first drag instruction of a user acted on a progress bar of a player, and adjusting the play progress to a first time point corresponding to an end position of the first drag instruction according to the first drag instruction;
when the first drag instruction is ended, generating a sub-progress bar at the end position of the first drag instruction, the sub-progress bar corresponding to a multimedia segment within a preset duration before and after the first time point; and
receiving a second drag instruction of the user acted on the sub-progress bar, and adjusting the play progress to a second time point corresponding to an end position of the second drag instruction according to the second drag instruction.

2. The method according to claim 1, wherein the adjusting the play progress to a second time point corresponding to an end position of the second drag instruction according to the second drag instruction comprises:
establishing a corresponding relationship table based on a corresponding relationship between a minimum drag length of the second drag instruction and a predetermined play duration; and
acquiring a drag length of the second drag instruction, obtaining a duration corresponding to the current drag length of the second drag instruction according to the corresponding relationship table, and correspondingly adjusting the play progress to the second time point according to the duration.

3. The method according to claim 1, wherein after the generating a sub-progress bar at an end position of the first drag instruction, comprises:
determining time points corresponding to all frames of the multimedia segment within the preset duration before and after the first time point, and
highlighting the time points in the sub-progress bar.

4. The method according to claim 1, wherein after the adjusting the play progress to a second time point corresponding to an end position of the second drag instruction, comprises:
pausing the play progress at the second time point, and detecting an operation event of the user acted on a player image; and
matching the operation event with a preset triggering condition; and if the operation event is successfully matched with the preset triggering condition, capturing a screen.

5. The method according to claim 4, wherein after the capturing a screen, comprises:
displaying a preview picture of a screen capture image, and popping up an edit box; and
receiving an edit instruction input through the edit box, modifying the screen capture image according to the edit instruction, and saving the screen capture image to a default directory.

6. An electronic device, comprising:
at least one processor; and
a memory communicably connected with the at least one processor for storing instructions executable by the at least one processor, wherein execution of the instructions by the at least one processor causes the at least one processor to:
receive a first drag instruction of a user acted on a progress bar of a player, and adjust the play progress to a first time point corresponding to an end position of the first drag instruction according to the first drag instruction;
when the first drag instruction is ended, generate a sub-progress bar at the end position of the first drag instruction, the sub-progress bar corresponding to a multimedia segment within a preset duration before and after the first time point; and
receive a second drag instruction of the user acted on the sub-progress bar, and adjust the play progress to a second time point corresponding to an end position of the second drag instruction according to the second drag instruction.

7. The electronic device according to claim 6, wherein the execution of the instructions by the at least one processor causes the at least one processor to:
establish a corresponding relationship table based on a corresponding relationship between a minimum drag length of the second drag instruction and a play duration corresponding to one frame, the corresponding relationship table comprising a corresponding relationship between the drag length and a play duration corresponding to the drag length; and
acquire a drag length of the second drag instruction, obtain a duration corresponding to the current drag length of the second drag instruction according to the corresponding relationship table, and correspondingly adjust the play progress to the second time point according to the duration.

8. The electronic device according to claim 6, wherein the execution of the instructions by the at least one processor causes the at least one processor to:
determine time points corresponding to all frames of the multimedia segment within the preset duration before and after the first time point, and
highlight the time points in the sub-progress bar.

9. The electronic device according to claim 6, wherein the execution of the instructions by the at least one processor causes the at least one processor to:
pause the play progress at the second time point; detect an operation event of the user acted on a player image; and
match the operation event with a preset triggering condition; and if the operation event is successfully matched with the preset triggering condition, capture a screen.

10. The electronic device according to claim 9, wherein the execution of the instructions by the at least one processor causes the at least one processor to:
display a preview picture of a screen capture image, and pop up an edit box; and
receive an edit instruction input through the edit box, modify the screen capture image according to the edit instruction, and save the screen capture image to a default directory.

11. The non-transitory computer-readable storage medium, storage medium storing executable instructions, wherein the execution of the instructions is executed by electronic device, causes the electronic device to:
receive a first drag instruction of a user acted on a progress bar of a player, and adjust the play progress to a first time point corresponding to an end position of the first drag instruction according to the first drag instruction;
when the first drag instruction is ended, generate a sub-progress bar at the end position of the first drag instruction, the sub-progress bar corresponding to a multimedia segment within a preset duration before and after the first time point; and
receive a second drag instruction of the user acted on the sub-progress bar, and adjust the play progress to a second time point corresponding to an end position of the second drag instruction according to the second drag instruction.

12. The non-transitory computer-readable storage medium according to claim 11, wherein the execution of the instructions is executed by electronic device, causes the electronic device to:
establish a corresponding relationship table based on a corresponding relationship between a minimum drag length of the second drag instruction and a play duration corresponding to one frame, the corresponding relationship table comprising a corresponding relationship between the drag length and a play duration corresponding to the drag length; and
acquire a drag length of the second drag instruction, obtain a duration corresponding to the current drag length of the second drag instruction according to the corresponding relationship table, and correspondingly adjust the play progress to the second time point according to the duration.

13. The non-transitory computer-readable storage medium according to claim 11, wherein the execution of the instructions is executed by electronic device, causes the electronic device to:
determine time points corresponding to all frames of the multimedia segment within the preset duration before and after the first time point, and
highlight the time points in the sub-progress bar.

14. The non-transitory computer-readable storage medium according to claim 11, wherein the execution of the instructions is executed by electronic device, causes the electronic device to:
pause the play progress at the second time point; detect an operation event of the user acted on a player image; and
match the operation event with a preset triggering condition; and if the operation event is successfully matched with the preset triggering condition, capture a screen.

15. The non-transitory computer-readable storage medium according to claim 14, wherein the execution of the instructions is executed by electronic device, causes the electronic device to:
display a preview picture of a screen capture image, and pop up an edit box; and
receive an edit instruction input through the edit box, modify the screen capture image according to the edit instruction, and save the screen capture image to a default directory.
